(19) United States
(12) Patent Application Publication
(10) Pub. No.: US 2026/0299764 A1
(43) Pub. Date: Oct. 1, 2026

(54) METHOD AND APPARATUS FOR DATA DISPLAY, DEVICE AND MEDIUM

(71) Applicant: Beijing Zitiao Network Technology Co., Ltd., Beijing (CN)

(72) Inventors: Chenyun ZENG, Beijing (CN); Shengfan HE, Beijing (CN)

(21) Appl. No.: 19/630,884

(22) Filed: Mar. 27, 2026

(30) Foreign Application Priority Data
Mar. 28, 2025 (WO) PCT/CN2025/085956

(51) Int. Cl. G06F 3/04842

(52) U.S. Cl. CPC G06F 3/04842

(57) ABSTRACT

The present disclosure provides a method and an apparatus for data display, a computing device, a computer readable storage medium, and a computer program product. The method includes: displaying a view comprising a time control indicating a period and a graphical representation of a dataset including data corresponding to the period, wherein the time control comprises a timeline control with a plurality of graphical elements corresponding to a plurality of sub-periods of the period; receiving a selection of at least one graphical element among the plurality of graphical elements; and highlighting subset data of the dataset corresponding to the at least one graphical element.

### CROSS-REFERENCE TO RELATED APPLICATION(S)

This application claims priority to PCT Application No. PCT/CN2025/085956 filed in Mar. 28, 2025, the disclosure of which is incorporated herein by reference in its entirety.

### FIELD

The present disclosure relates to the technical field of computers, and more specifically, to a method and an apparatus for data display, a computing device, a computer readable storage medium and a computer program product.

### BACKGROUND

In typical data analysis, a time filter is a common tool for selecting data within a specific period. For example, a user may desire to view specific data over the past week, month or year to examine the data changes. According to conventional technical solutions, the user can select a period by dragging the timeline or inputting a date range; after the filtering has been completed, the data corresponding to the selected period is displayed on the display interface.

### SUMMARY

Embodiments of the present disclosure provide a method and an apparatus for data display, a computing device, a computer storage medium and a computer program product.

In a first aspect of the present disclosure, there is provided a method of data display, comprising: displaying a view comprising a time control indicating a period and a graphical representation of a dataset including data corresponding to the period, wherein the time control comprises a timeline control with a plurality of graphical elements corresponding to a plurality of sub-periods of the period; receiving a selection of at least one graphical element among the plurality of graphical elements; and highlighting subset data of the dataset corresponding to the at least one graphical element.

In a second aspect of the present disclosure, there is provided an apparatus for data display, comprising: a view display unit configured to display a view comprising a time control indicating a period and a graphical representation of a dataset including data corresponding to the period, wherein the time control comprises a timeline control with a plurality of graphical elements corresponding to a plurality of sub-periods of the period; an input receiving unit configured to receive a selection of at least one graphical element among the plurality of graphical elements; and a highlighting unit configured to highlight subset data of the dataset corresponding to the at least one graphical element.

In a third aspect of the present disclosure, there is provided a computing device, comprising: at least one processing unit; and at least one memory coupled to the at least one processing unit and storing instructions executable by the at least one processing unit, wherein the instructions, when executed by the at least one processing unit, cause the computing device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. In the drawings, multiple embodiments of the present disclosure are depicted in an exemplary, but non-limiting, manner, where:

FIG. 1 illustrates a schematic flowchart of a method for data display according to embodiments of the present disclosure;

FIG. 2 illustrates a schematic diagram of a view showing a time control in a collapsed state according to embodiments of the present disclosure;

FIG. 3 illustrates a schematic diagram of a view showing the time control in an expanded state according to embodiments of the present disclosure;

FIG. 4 illustrates a schematic diagram of a view in which subset data corresponding to a selected graphical element is displayed according to embodiments of the present disclosure;

FIG. 5 illustrates a schematic diagram of a view showing playback of the subset data according to embodiments of the present disclosure;

FIG. 6 illustrates a schematic diagram of a view showing the playback of the subset data being paused according to embodiments of the present disclosure ;

FIG. 7 illustrates a block diagram of an apparatus for data display according to embodiments of the present disclosure; and

FIG. 8 illustrates a block diagram of an electronic device according to embodiments of the present disclosure.

Throughout the drawings, the same or similar reference numerals represent the same or similar elements.

### DETAILED DESCRIPTION OF EMBODIMENTS

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

Hereinafter, reference will be made to the drawings to describe the basic principle and implementations of the present disclosure. It would be appreciated that the example embodiments are provided only to enable those skilled in the art to better understand and further carry out the embodiments of the present disclosure, rather than suggest any limitation to the scope of the present disclosure.

Conventional time filters have notable shortcomings. First, after selecting a time period, users cannot directly view a data fluctuation trend within the time period. For example, to quickly identify daily peaks or troughs in traffic over a selected month, the user must switch to other charts (e.g. line charts, or bar charts), which is cumbersome and inefficient. Second, since users cannot directly view data details for a specific time point within the selected period, they are forced to repeatedly adjust the filter conditions or interact with other charts.

As mentioned above, in the existing scenario of viewing data based on the time filter, users cannot directly capture the data fluctuation trend within a selected period in the timer filter, nor can they straightforwardly view data details for a specific time point in the time filter. In other words, the existing time filter-based data viewing methods cannot meet the requirements for quick data inspection in the visualization or big data scenarios.

To this end, the present disclosure provides a method for data display. In the method, a time control and a graphical representation of a dataset can be displayed in a view, where the time control indicates a period, and the dataset includes data corresponding to the period. The time control includes a timeline control (e.g. located in the expanded area) in which a plurality of graphical elements (e.g. bar charts) corresponding to a plurality of sub-periods of the period are displayed. For example, the timeline control may display each day in a month, 24 hours in a day, or the like. When expecting to view data in a sub-period, a user can select a corresponding graphical element on the timeline control. In response to one or more graphical elements being selected, subset data corresponding to the selected graphic elements in the dataset is highlighted. Optionally, data for each day can be played automatically in chronological order to display a data fluctuation trend.

With the method, the present disclosure can solve the problem that data fluctuation trends in a period cannot be directly viewed during time filtering. By introducing a timeline helpful for analyzing a data fluctuation trend and combining graphical elements in the timeline with the time filtering function of the time control, the present disclosure not only enables time-based filtering, but can also allow users to intuitively view data fluctuations within the selected period. This enables clear and straightforward visualization of data trends, thereby meeting the requirements for quick data inspection in visualization or big data scenarios.

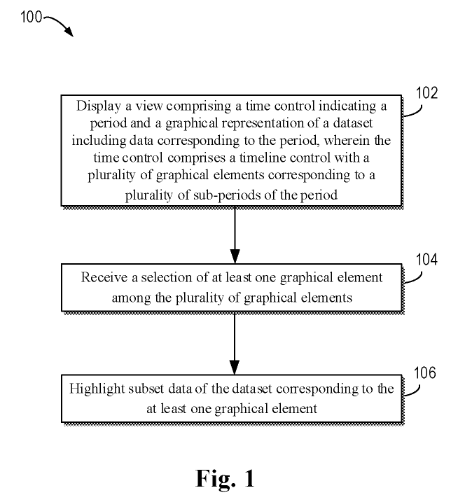

FIG. 1 illustrates a schematic flowchart of a method 100 for data display according to embodiments of the present disclosure. The method can be implemented by any electronic device with computing and display capabilities, including, but not limited to, a mobile phone, a tablet, a wearable device, an on-vehicle device, an augmented reality/virtual reality device, a laptop computer, an ultra-mobile personal computer, a netbook computer, a personal digital assistant, an IoT device, an industrial terminal, and other electronic device with an interface display function. The specific type of the electronic device is not limited herein.

In the method 100 as shown in FIG. 1, at block 102, display a view including a time control indicating a period and a graphical representation of a dataset including data corresponding to the period, where the time control includes a timeline control with a plurality of graphical elements corresponding to a plurality of sub-periods of the period. As used herein, the timeline control may bealso referred to as timeline for brevity.

In some implementations, the timeline can be displayed and hidden through a user input. For example, when the timeline is not displayed (also referred to as collapsed state), the user can click a button or icon on the time control, to cause the timeline to expand from the time control, thereby switching the time control to its expanded state. Similarly, in a case that the time control is in the expanded state to display the timeline, the user can click a button or icon on the time control to hide or collapse the timeline, thereby switching the time control to its collapsed state. With the method, the timeline can be flexibly expanded or collapsed, to prevent a long-time expansion of the timeline from affecting the straightforward display of the graphical representation of the dataset.

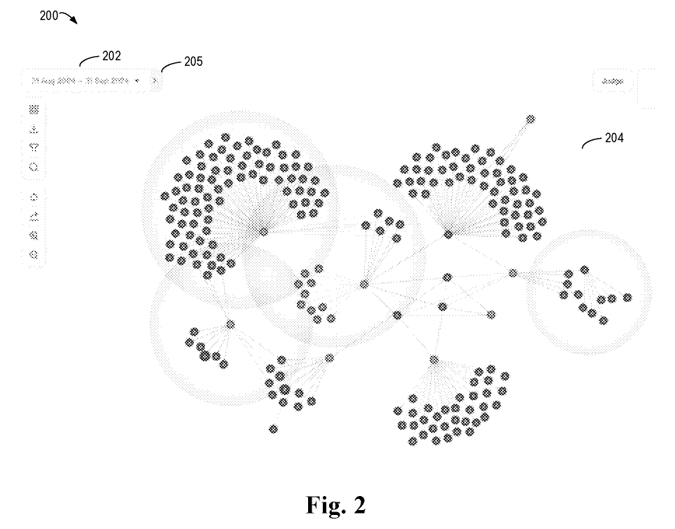

FIG. 2 illustrates a schematic diagram of a view showing a time control in a collapsed state according to embodiments of the present disclosure. As shown therein, the view 200 displayed on the screen may include a time control 202 and a graphical representation 204 of a dataset. The time control 204 indicates a period of a month, and the graphical representation 204 demonstrates visualization of data for this month.

By way of example, the graphical representation 204 of the dataset includes a point-edge relationship graph. The point-edge relationship graph (typically referred to as graph structure) is comprised of points (also referred to as nodes) and edges. The nodes are used to represent various entities, and edges are used to represent relationship between the nodes. For example, in a social network, if users are considered as nodes and the follow or friend relationship between users are considered as edges. This forms a graph illustrating the social connections among users. It would be appreciated that the graphical representation of the dataset may be a line chart, a bar chart, or any other graphical representation of the dataset, which is not limited herein.

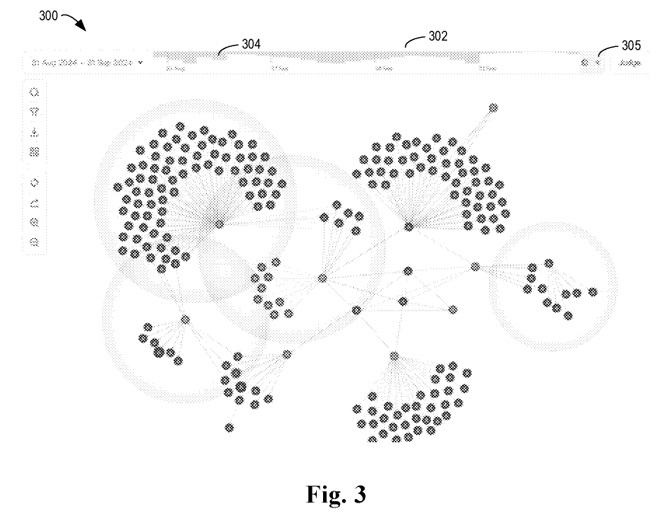

In an initial or default state, the timeline may not be displayed. The time control 202 may include an expand button 205. When the user clicks or touches the expand button 205, the time control 202 is expanded, and the extended timeline is displayed as well, as shown in FIG. 3.

FIG. 3 illustrates a schematic diagram of a view 300 showing the time control in an expanded state according to embodiments of the present disclosure. As shown therein, the expanded time control has a timeline 302 including multiple graphical elements 304, each corresponding to one of multiple sub-periods (sometimes also referred to as time point) of a period indicated by the time control. By way of example, the timeline 302 may include a multiple bars corresponding to the multiple sub-periods of the period, for example, including the bar 304 and other unlabeled bars. It would be appreciated that the graphical elements may also be of other shapes, which is not limited herein.

In some embodiments, a time granularity represented by the graphical element 304 in the timeline 302 can be determined based on the length of the period. The time granularity may include any one type of months, weeks, days, hours, and minutes, which is not limited herein. In general, the period is divided into several to dozens of sub-periods, to facilitate analysis and observation. For example, when the current period length is approximately one month, each graphical element 304 may indicate a day; or if the period spans one or two days, each graphical element may indicate an hour. Optionally, the user can manually set the granularity of the graphical element 304.

In some embodiments, the size of the graphical element 304 is associated with data volume of corresponding subset data. By way of example, in FIG. 3, the size of the graphical element 304 is associated with a number of nodes included in the corresponding subset data. A larger number of nodes included in the subset data indicates a greater size of the graphical element 304; or a smaller number of nodes included in the subset data 404 indicates a smaller size of the graphical element 304. In this way, the user can directly view the data volume for each time point within the period from the timeline.

As shown therein, the time control further includes a collapse button 305. In the view 300, in response to that the user clicks or touches the collapse button 305 to collapse the timeline 302, i.e., to return to the view 200 in FIG. 2.

Continuing with FIG. 1, at block 104, receive a selection of at least one graphical element among the plurality of graphical elements. Each graphical element is a clickable filter button, and by receiving the user selection on the graphical element, a sub-period corresponding to the graphical element can be determined to apply data filtering.

At block 106, highlight subset data of the dataset corresponding to the at least one graphical element. In some embodiments, based on the at least one selected graphical element, a sub-period corresponding to the graphical element is determined. Based on the sub-period, subset data corresponding to the sub-period can be determined. Then, the subset data corresponding to the sub-period is highlighted.

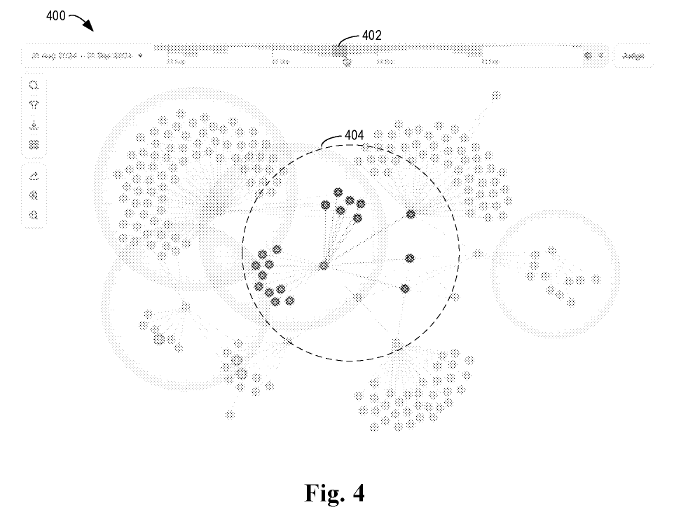

FIG. 4 illustrates a schematic diagram of a view 400 in which subset data corresponding to a selected graphical element is displayed according to embodiments of the present disclosure. In the view 400, a graphical element 402 is selected by a user. In response, subset data 404 corresponding to the graphical element 402 is highlighted in the view 400 while other data are displayed in gray. For example, when the data is visualized as a point-edge relationship graph, nodes containing time information for the day where the selected graphical element 402 is located, as well as edges connecting those nodes, are highlighted. It would be appreciated that the user can select more than one graphical element, and correspondingly, subset data for more time points can be displayed concurrently in the view 400.

In this way, the present disclosure can determine, based on a graphical element selected from a plurality of graphical elements, subset data corresponding to the graphical element, and highlight the subset data, to thus enable users to view details of data corresponding to a specific time point in a quick and straightforward manner.

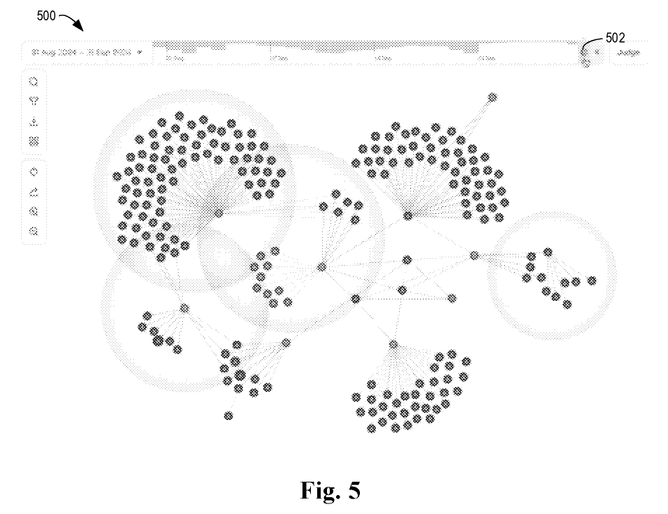

FIG. 5 illustrates a schematic diagram of a view 500 showing playback of the subset data according to embodiments of the present disclosure. As shown therein, the time control includes a playback control 502.

In some embodiments, in response to the playback control 502 being triggered, subset data corresponding to multiple sub-periods are highlighted sequentially in chronological order. By way of example, when the playback control 502 is triggered, subset data for sub-periods corresponding to the graphical elements of the time control 202, in the order from the leftmost to the rightmost graphical element, can highlighted sequentially. Optionally, the user can label a part of the graphical elements within the whole period, and can then click the playback control 502 to play subset data for the selected time points. In some embodiments, in response to the playback control 502 being triggered, graphical elements on the timeline are highlighted sequentially in chronological order.

With the method, subset data corresponding to multiple of sub-periods can be highlighted sequentially in chronological order, to enable users to directly view dynamic changes of data for the selected period.

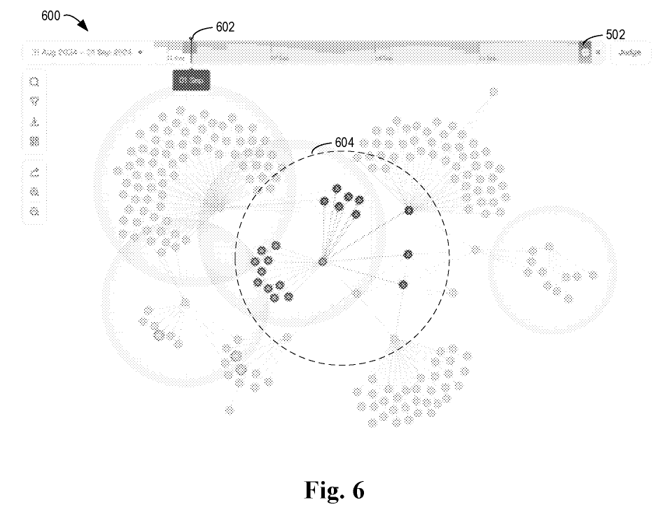

FIG. 6 illustrates a schematic diagram of a view showing the playback of the subset data being paused according to embodiments of the present disclosure.

In some embodiments, in response to receiving a pause playback instruction (e.g. clicking the play button 502 again), the playback process shown in FIG. 5 is paused, and the sub-period at which the pause playback instruction occurs is determined.. As shown, subset data 604 corresponding to the period is highlighted. In some embodiments, a graphical element 604 corresponding to the sub-period can be highlighted at the same time.

In some embodiments, information of the sub-period corresponding to the graphical element is displayed below the timeline control 302, which may be September 1, for example. It would be appreciated that the description of displaying a sub-period corresponding to a graphical element is provided only as an example, and the sub-period may be any appropriate period, which is not limited herein.

With the method, the pause playback command may be utilized to determine the sub-period at which the playback is paused, and to highlight the subset data corresponding to the determined sub-period. This enables a user to, during the process of playing back the subset data, determine a sub-period to be paused based on actual needs, thereby allowing the user to intuitively view detailed data associated with the sub-period.

The example embodiments described above with reference to FIGS. 1-6 provide a method for data display. As compared with prior art, the present disclosure has the following advantages: by incorporating a data fluctuation trend into an expanded area of the time control and integrating multiple graphical elements with the time filtering functionality of the time control, the present disclosure not only enables time-based filtering, but also allows users to view data fluctuations within a selected period. This facilitates the straightforward and clear presentation of data variations, thereby meeting the requirements for quick data inspection in visualization or big data scenarios and enhancing the user experience when viewing detailed data through the time control.

FIG. 7 illustrates a schematic block diagram of an apparatus 700 for data display according to embodiments of the present disclosure. The apparatus 700 can be used to implement the method or steps described with reference to FIGS. 1-6.

As shown therein, the apparatus 700 includes: a view display unit 702, an input receiving unit 704 and a highlighting unit 706. The view display unit 702 is configured to display a view comprising a time control indicating a period and a graphical representation of a dataset including data corresponding to the period, where the time control comprises a timeline control with a plurality of graphical elements corresponding to a plurality of sub-periods of the period. The input receiving unit 704 configured to receive a selection of at least one graphical element among the plurality of graphical elements. The highlighting unit 706 is configured to highlight subset data of the dataset corresponding to the at least one graphical element.

In some embodiments, the view further includes a playback control. The view display unit 702 can be configured, in response to the playback control being triggered, to sequentially highlight subset data corresponding to the plurality of sub-periods in chronological order.

In some embodiments, the view display unit 702 can be configured to: in response to receiving a pause instruction, determine a first sub-period at which playback is paused; and highlight subset data corresponding to the first sub-period.

In some embodiments, the time control comprises an expand control and a collapse control. In some embodiments, the view display unit 702 can be configured to: in response to receiving a first input on the time control, expand the timeline control; and in response to receiving a second input on the time control, collapse the timeline control.

In some embodiments, the first input is an input on the expand control, and the second input is an input on the collapse control of the time control.

In some embodiments, a time granularity represented by the plurality of graphical elements is determined based on a length of the period.

In some embodiments, the highlighting unit z can also be configured, in response to receiving a selection of the at least one graphical element among the plurality of graphical elements, to highlight the at least one graphical element in the view.

In some embodiments, a size of each graphical element among the plurality of graphical elements is associated with a data volume of corresponding subset data.

It is worth noting that more actions or steps as shown in FIGS. 1-6 can be implemented by the apparatus 700 as shown in FIG. 7. For example, the apparatus 700 may include more modules or units to implement the actions or steps described above, or some units or modules shown in FIG. 7 can be further configured to implement the actions or steps described above. Details are omitted here for brevity.

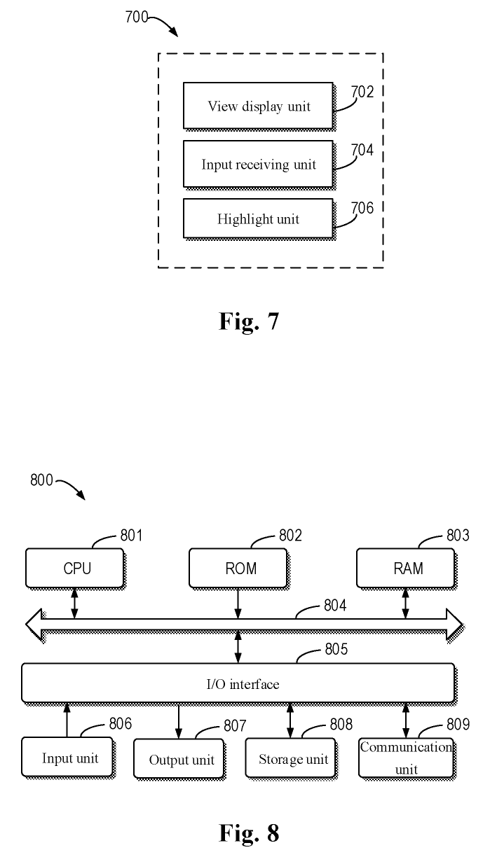

FIG. 8 illustrates an example block diagram of an example device 800 that can implement embodiments of the present disclosure. As shown therein, the device 800 may include a computing unit 801 which can execute various actions and processing based on programs stored in a Read Only Memory (ROM) 802 or a program loaded from a storage unit 806 to a Random Access Memory (RAM) 803. RAM 803 stores therein various programs and data required for operations of the device 800. The computing unit 801, the ROM 802, and the RAM 803 are connected to one another via a bus 804. An input/output (I/O) interface 805 is also connected to the bus 804.

A plurality of components in the device 800 may be connected to the I/O interface 805, including: an input unit 806 including, for example, a keyboard, a mouse, and the like; an output unit 807 including various types of displays, loudspeakers, and the like; a storage unit 808 including, for example, a magnetic disk, a compact disc, or the like; and a communication unit 809, for example, a network card, a modem, a wireless communication transceiver, or the like. The communication unit 809 can allow the device 800 to exchange information/data with other devices through a computer network such as Internet, and/or various kinds of telecommunication networks.

The computing unit 801 may be various types of general purpose and/or specific purpose processing components having a processing and computing capability. Some examples of the computing unit 801 include, but are not limited to, a Central Processing Unit (CPU), a Graphics Processing Unit (GPU), various types of specific-purpose Artificial Intelligence (AI) computing chips, various types of computing units having machine learning model algorithms run thereon, a Digital Signal Processor (DSP), any appropriate processor, controller, microcontroller, or the like. The computing unit 801 can execute various methods and processing described above, for example, the method 100. For example, the method 100 may be implemented as computer software programs that are tangibly included in a machine readable medium, e.g., the storage unit 808. In some embodiments, part or all of the computer programs may be loaded and/or mounted onto the device 800 via ROM 802 and/or communication unit 809. When the computer program is loaded to the RAM 803 and executed by the computing unit 801, one or more steps of the method 100 as described above may be executed. Alternatively, in other embodiments, the computing unit 801 may be configured in any other appropriate manners (for example, by means of firmware) to perform the method 100.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for data display, comprising:
displaying a view comprising a time control indicating a period and a graphical representation of a dataset including data corresponding to the period, wherein the time control comprises a timeline control with a plurality of graphical elements corresponding to a plurality of sub-periods of the period;
receiving a selection of at least one graphical element among the plurality of graphical elements; and
highlighting subset data of the dataset corresponding to the at least one graphical element.

2. The method of claim 1, wherein the view further comprises a playback control, and the method further comprises:
in response to the playback control being triggered, sequentially highlighting subset data corresponding to the plurality of sub-periods in chronological order.

3. The method of claim 2, further comprising:
in response to receiving a pause instruction, determining a first sub-period at which playback is paused; and
highlighting subset data corresponding to the first sub-period.

4. The method of claim 1, wherein the time control comprises an expand control and a collapse control, and the method further comprises:
in response to receiving a first input on the time control, expanding the timeline control; and
in response to receiving a second input on the time control, collapsing the timeline control.

5. The method of claim 4, wherein the first input is an input on the expand control, and the second input is an input on the collapse control of.

6. The method of claim 1, wherein a time granularity represented by the plurality of graphical elements is determined based on a length of the period.

7. The method of claim 1, further comprising:
in response to receiving a selection of the at least one graphical element among the plurality of graphical elements, highlighting the at least one graphical element in the view.

8. The method of claim 1, wherein a size of each graphical element among the plurality of graphical elements is associated with a data volume of corresponding subset data.

9. A computing device, comprising:
at least one processing unit; and
at least one memory coupled to the at least one processing unit and storing instructions executable by the at least one processing unit, wherein the instructions, when executed by the at least one processing unit, cause the computing device to perform a method comprising:
displaying a view comprising a time control indicating a period and a graphical representation of a dataset including data corresponding to the period, wherein the time control comprises a timeline control with a plurality of graphical elements corresponding to a plurality of sub-periods of the period;
receiving a selection of at least one graphical element among the plurality of graphical elements; and
highlighting subset data of the dataset corresponding to the at least one graphical element.

10. The computing device of claim 9, wherein the view further comprises a playback control, and the method further comprises:
in response to the playback control being triggered, sequentially highlighting subset data corresponding to the plurality of sub-periods in chronological order.

11. The computing device of claim 10, the method further comprising:
in response to receiving a pause instruction, determining a first sub-period at which playback is paused; and
highlighting subset data corresponding to the first sub-period.

12. The computing device of claim 9, wherein the time control comprises an expand control and a collapse control, and the method further comprises:
in response to receiving a first input on the time control, expanding the timeline control; and
in response to receiving a second input on the time control, collapsing the timeline control.

13. The computing device of claim 12, wherein the first input is an input on the expand control of the time control, and the second input is an input on the collapse control of the time control.

14. The computing device of claim 9, wherein a time granularity represented by the plurality of graphical elements is determined based on a length of the period.

15. The computing device of claim 9, the method further comprising:
in response to receiving a selection of the at least one graphical element among the plurality of graphical elements, highlighting the at least one graphical element in the view.

16. The computing device of claim 9, wherein a size of each graphical element among the plurality of graphical elements is associated with a data volume of corresponding subset data.

17. A computer program product comprising machine-executable instructions that, when executed by a device, cause the device to perform a method comprising:
displaying a view comprising a time control indicating a period and a graphical representation of a dataset including data corresponding to the period, wherein the time control comprises a timeline control with a plurality of graphical elements corresponding to a plurality of sub-periods of the period;
receiving a selection of at least one graphical element among the plurality of graphical elements; and
highlighting subset data of the dataset corresponding to the at least one graphical element.

18. The computer program product of claim 17, wherein the view further comprises a playback control, and the method further comprises:
in response to the playback control being triggered, sequentially highlighting subset data corresponding to the plurality of sub-periods in chronological order.

19. The computer program product of claim 18, the method further comprising:
in response to receiving a pause instruction, determining a first sub-period at which playback is paused; and
highlighting subset data corresponding to the first sub-period.

20. The computer program product of claim 17, wherein the time control comprises an expand control and a collapse control, and the method further comprises:
in response to receiving a first input on the time control, expanding the timeline control; and
in response to receiving a second input on the time control, collapsing the timeline control.
